(19) United States
(12) Patent Application Publication
(10) Pub. No.: US 2009/0042100 A1
(43) Pub. Date: Feb. 12, 2009

(54) NON-AQUEOUS ELECTROLYTE BATTERY AND NEGATIVE ELECTRODE USED THEREIN

(75) Inventors: Masaaki TANAKA, Moriguchi-shi (JP); Hiroshi MINAMI, Moriguchi-shi (JP); Naoki IMACHI, Moriguchi-shi (JP); Takeshi OGASAWARA, Moriguchi-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/188,597

(22) Filed: Aug. 8, 2008

(30) Foreign Application Priority Data
Aug. 10, 2007 (JP) 2007-209173

(51) Int. Cl. H01M 4/62

(52) U.S. Cl. 429/217; 429/246

(57) ABSTRACT

In a negative electrode for a non-aqueous electrolyte battery, in which a negative electrode active material layer (2) containing a negative electrode active material and a water-based binder for the negative electrode active material layer is formed on the surface of a negative electrode current collector (1), a porous layer (3) containing inorganic particles and a non-water based binder for the porous layer is formed on the surface of the negative electrode active material layer (2). The binder for the negative electrode active material layer contains carboxymethyl cellulose (CMC) whose degree of etherification is 0.5 or greater and 0.75 or less.

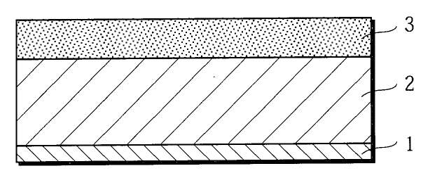

### BACKGROUND OF THE INVENTION

1. Field of the Invention

The present invention relates to the improvements of non-aqueous electrolyte batteries, such as lithium-ion batteries or polymer batteries, and of negative electrodes used in these kinds of batteries. Particularly, the invention relates to, for example, a battery design which can improve the adhesion strength of the negative electrode to achieve higher levels of reliability.

2. Description of Related Art

In recent years, the rapid reductions in size and weight of mobile phones, notebook computers, personal digital assistants (PDAs) and other mobile information devices have created a demand for batteries with higher capacities as the power sources for those devices. One such battery is the lithium-ion battery, in which the charge-discharge reactions take place with lithium ions shuttling between the positive and negative electrodes. Because of its high energy-density and high capacity, the lithium-ion battery is generally used as a power source for various mobile information devices as listed earlier.

Recent mobile information devices show a tendency to consume more power due to the expansion and sophistication of their functions, such as showing movies or playing games. Accordingly, there is a strong demand for their power sources, i.e. the lithium-ion battery, to have higher capacities and better performance that provide a longer playing time, higher output power and so on. Furthermore, it is also desired to increase the output power of the lithium-ion battery as well as its capacity since the battery is expanding its application areas in addition to mobiles phones and other earlier mentioned devices. For example, the lithium-ion battery has been recently employed in hybrid electric vehicles (HEV) and electric tools. Thus, the recent efforts of developing lithium-ion batteries are oriented in two major directions, that is, increasing capacity and increasing power.

Increasing the capacity is accompanied by problems of non-uniform reactions and heat accumulation inside the battery, resulting from an increase in the filling density. Increasing the power has to solve several problems, such as the heat generation resulting from an increase in the battery size or from the charging/discharging of high-current. Furthermore, both developing efforts share the problem of ensuring the safety and reliability of the battery, which is becoming more and more challenging. Thus, for the development of the lithium-ion battery, ensuring the safety while coping with the diversification of application areas is also an important subject.

A conventional method for improving the reliability of the battery has been proposed in Japanese Patent No. 3371301 and Japanese Unexamined Patent Application Publication No. 2005-174792, in which a porous layer made of inorganic fine particles is formed between the electrodes and the separator so as to prevent short-circuits between the positive and negative electrodes in the case of internal short-circuits and thereby enhance the safety level. Another conventional battery, proposed in Japanese Unexamined Patent Application Publication Nos. 2007-123237 and 2007-123238, also includes a porous layer between the electrodes and the separator with the intention of improving the permeability of the electrolyte solution across the entire surface of the electrode by a capillarity effect and thereby equalizing the reaction so as to improve the battery performance, such as the cycle characteristics.

As represented by these proposals, recent efforts for improving the reliability of the battery have increasingly focused on the battery structure, such as the introduction of new layers that are not used in older batteries, in addition to the conventional, material-oriented approaches concerned with better preparation or selection of active materials, electrolytes, separators and other elements.

As stated above, forming a new layer (e.g. a porous layer) on the surface of an electrode or separator has been one of the important requirements for improving the reliability of the battery. In most cases, the new layer is made of a material that will not be involved in the charge-discharge reactions of the battery. Therefore, the layer is normally formed by thin-film coating with a thickness on the order of several micrometers in order to minimize the decrease in the energy density of the battery. Creating an adequately strong, uniform film is particularly important when the film is to be formed on an electrode, since the base material, i.e. the electrode, is porous and its surface is uneven. Given this factor, the layer is often formed by a technique suitable for creating thin films, such as gravure coating. The thin-film layer is generally over-painted on an active material layer which is formed in advance as the base material. Therefore, the coating solution for the active material layer is normally prepared using a solvent different from the solvent contained in the coating solution for the porous layer. This alleviates damage to the electrode, such as the active material layer peeling from the current collector.

As a specific example, suppose that a negative electrode for a lithium-ion battery is to be manufactured. In this case, the negative electrode active material layer is created using water as the solvent for preparing a slurry in which a negative electrode active material (e.g. carbon) and a binder (e.g. carboxymethyl cellulose (CMC) or styrene-butadiene rubber (SBR)) are dispersed, whereas the porous layer, which will be the surface layer, is created using N-methyl-2-pyrrolidone (NMP) as the solvent for preparing a slurry in which filler particles and a binder (e.g. polyvinylidene fluoride (PVDF)) are dispersed. The use of a water-based binder for the negative electrode active material layer and a non-water based binder for the porous layer is intended to prevent intimate mixing of the porous layer into the negative electrode active material layer and thereby minimize damage to the resultant electrode. The use of binders of different solvent groups also effectively prevents other problems; if binders of the same solvent group were used for both layers, the binder that had been used for forming the negative electrode active material layer would later be re-dissolved, causing problems such as the peeling of the negative electrode active material layer or an uneven formation of the porous layer, so that it would be impossible to apply an accurate amount of the slurry in an accurate thickness to obtain a uniform electrode plate.

However, the inventors have found that even if, as described above, the kind of solvent component used for forming the negative electrode active material layer differs from that of the solvent component used for forming the porous layer, the adhesion strength of the negative electrode current collector and the negative electrode active material (which may hereinafter be called the “adhesion strength of the electrode”) significantly decreases since the solvent component of the slurry used for forming the porous layer permeates into the negative electrode active material layer.

In recent years, negative electrodes have been subjected to a rolling process after the formation of the negative electrode active material layer in order to increase the filling density of the negative electrode active material. This process compresses the negative electrode active material layer and results in a decrease in the degree of porosity of the negative electrode active material layer. Therefore, by forming the porous layer after the rolling process, it is possible to somewhat impede the permeation of the solvent component (e.g. NMP) of the slurry into the negative electrode active material layer in the process of forming the porous layer. However, the problem of a decrease in the adhesion strength of the electrode still remains since it is difficult to completely prevent the permeation.

Thus, although the formation of a porous layer on the surface of the negative electrode is indispensable for improving the battery's performance, this technique is currently far from the goal since the permeation of the solvent component of the porous-layer slurry into the negative electrode active material layer causes a drastic decrease in the adhesion strength of the electrode, making the resulting battery too fragile to undergo a manufacturing process. To achieve this goal, it is urgent to find appropriate materials and establish a method for forming a porous layer on the negative electrode without decreasing the adhesion strength of the electrode. The minimal requirement for the adhesion strength of the electrode is that the battery should be able to withstand the manufacturing process. However, the adhesion strength of the electrode may later decrease due to a side reaction, such as the decomposition of electrolyte inside the battery, resulting from the cycling process, high-temperature storage or other reasons. Accordingly, it is preferable to give the electrode the highest possible adhesion strength to ensure the electron conductivity inside the electrode.

Thus, an objective of the present invention is to provide a non-aqueous electrolyte battery and a negative electrode used in this battery in which the electron conductivity between the negative electrode active material and the negative electrode current collector is ensured by preventing the adhesion strength of the negative electrode current collector and the negative electrode active material from decreasing even if a porous layer is formed on the surface of the negative electrode.

### BRIEF SUMMARY OF THE INVENTION

To achieve the above objective, the present invention provides a negative electrode for a non-aqueous electrolyte battery, including a negative electrode active material layer formed on a negative electrode current collector, the negative electrode active material layer containing a negative electrode active material and a water-based binder for the negative electrode active material layer, wherein: a porous layer containing an inorganic particle and a non-water based binder for the porous layer is formed on the surface of the negative electrode active material layer; and the binder for the negative electrode active material layer contains carboxymethyl cellulose whose degree of etherification is 0.5 or greater and 0.75 or less.

### DETAILED DESCRIPTION OF THE INVENTION

Research conducted by the inventors has revealed that, if carboxymethyl cellulose (which may hereinafter be abbreviated as CMC) is contained in the binder for the negative electrode active material layer, the adhesion of the negative electrode active material layer and the negative electrode current collector is mainly ensured by the presence of CMC. It has been found that permeation of an organic solvent (e.g. NMP) into the negative electrode active material layer during the process of forming the porous layer will decrease the adhesion strength of CMC and the negative electrode current collector, as explained earlier. This mechanism is not clarified yet; a possible reason is that the organic solvent permeates into a region that is strongly involved in creating the bond between the negative electrode current collector and CMC and thereby weakens their interactions. [A detailed investigation is underway. A current presumption is that the affinity of a rust-preventing agent (a chromate-based or imidazole-based one), which is applied to the copper foil used as the negative electrode current collector in the non-aqueous electrolyte battery, with a hydroxyl group of CMC may be contributing to the binding strength.]

From this reasoning, the inventors have carried out experiments, whose results demonstrated that the binding strength between the negative electrode current collector and the negative electrode active material is most likely governed by the degree of etherification of CMC, and decreasing this value to 0.75 or less will inhibit the decrease in the binding capacity resulting from the permeation of the organic solvent (e.g. NMP) used for forming the porous layer. However, CMC is very difficult to dissolve in water if its degree of etherification is less than 0.5. Therefore, it is necessary to control the degree of etherification of CMC to be 0.5 or greater and 0.75 or less.

The reason for the use of a water-based binder for the negative electrode active material layer and a non-water based binder for the porous layer rests on environmental considerations; that is, forming the negative electrode active material layer requires a larger amount of solvent than in the case of forming the porous layer, so it is reasonable to use the environment-friendly water solvent in the process of forming the negative electrode active material layer.

As regards to CMC contained in the negative electrode, Japanese Unexamined Patent Application Publication No. H11-67213 states that use of CMC with a degree of etherification of 0.5 or greater and 1.0 or less and a mean degree of polymerization of 300 or greater and 1800 or less will yield an improved binding strength and other preferable effects. However, as is evident from the experiments to be described later, it is possible to ensure an adequate adhesion strength of the negative electrode current collector and the negative electrode active material layer without controlling the degree of etherification of CMC as described previously if no porous layer is formed on the surface of the negative electrode active material layer.

In other words, from the viewpoint of ensuring an adequate adhesion strength of the negative electrode current collector and the negative electrode active material layer, it is not absolutely necessary to control the degree of etherification of CMC if no porous layer is formed; controlling the degree of etherification of CMC will be beneficial only when the porous layer is formed. This point should be regarded as a significant difference between the technique disclosed in the aforementioned publication and the present invention.

It is preferable that the degree of etherification of CMC be 0.65 or greater and 0.75 or less.

Raising the lower limit of the degree of etherification of CMC to 0.65 will further increase the solubility of CMC and thereby improve the efficiency of the manufacturing work.

It is preferable that the proportion of CMC to the total amount of the negative electrode active material layer be 0.7 mass % or greater and 1.5 mass % or less.

CMC mainly governs the binding of the negative electrode active material and also the adhesion of the negative electrode active material and the negative electrode current collector. If the proportion of CMC is less than 0.7 mass %, the binding strength of the negative electrode active material and the adhesion strength of the negative electrode active material and the negative electrode current collector will be too low. On the other hand, if the proportion of CMC exceeds 1.5 mass %, the capacity of the negative electrode active material for lithium ions will be lower and the battery's performance (particularly, the load characteristic) will deteriorate accordingly.

It is preferable that a binder for giving flexibility to the negative electrode active material layer be contained as the binder for the negative electrode active material layer in addition to CMC. This binder may be hereinafter called the “additional binder for the negative electrode active material layer” or simply “additional binder.”

As explained previously, the binding strength of the negative electrode active material layer can be ensured by controlling the degree of etherification of CMC. Meanwhile, the negative electrode may be bent or flexed during the manufacturing process of certain kinds of batteries, such as cylindrical batteries. Accordingly, it is preferable that the negative electrode active material layer contain an additional binder, as stated above, in order to ensure the necessary flexibility as well as the binding strength. For example, styrene-butadiene rubber (SBR), acrylic resins or nitrile resins can be used as the additional binder for the negative electrode active material layer.

It is preferable that the proportion of the additional binder for the negative electrode active material layer, to the total amount of the negative electrode active material layer be 0.5 mass % or greater and 1.5 mass % or less.

The additional binder should be preferably contained at 0.5 mass % or greater in order to ensure an adequate level of flexibility for preventing the peeling of the negative electrode active material from the negative electrode current collector or other problems in the process of manufacturing the non-aqueous electrolyte battery. However, if the proportion of the additional binder exceeds 1.5 mass %, the capacity of the negative electrode active material for lithium ions will be lower and the battery's performance will deteriorate accordingly, as in the case of CMC. Therefore, the upper limit of the additional binder should be preferably 1.5 mass % or less.

It is preferable that the structure of the additional binder for the negative electrode active material layer be similar to that of the binder for the porous layer.

As explained earlier, the bonding strength at the interface between the negative electrode current collector and the negative electrode active material layer can be significantly increased by controlling the degree of etherification of CMC. Similarly, it is preferable to increase the bonding strength at the interface between the negative electrode active material layer and the porous layer. In this case, the additional binder for the negative electrode active material layer will most likely govern the bonding strength between the negative electrode active material layer and the porous layer, as will be explained later. When the bonding of the negative electrode active material layer and the porous layer is to be considered, it is necessary to also focus attention on the binder contained in the porous layer; that is, the binder for the porous layer must be carefully and appropriately selected as well as the additional binder for the negative electrode active material layer. Specifically, if the two binders have entirely different structures (for example, such as the case where SBR, which is a latex-based compound, is used as the additional binder for the negative electrode active material layer, whereas PVDF, which is a fluorine-based compound, is used as the binder for the porous layer), then the structural interaction that affects the binding strength of the two layers will be weakened, so that the binding strength cannot be adequately improved. On the other hand, if the two binders have similar structures (for example, such as the case where a water-based acrylic resin is used as the additional binder for the negative electrode active material layer while a non-water-based acrylic resin is used as the binder for the porous layer), then the structural interaction that affects the binding strength of the two layers will be enhanced, so that the binding strength can be adequately improved. It should be noted that the selection of two structurally similar binders is not limited to the preceding example using acrylic resins as the two binders; it is possible to use any pair of resins sharing the same basic structure. For example, nitrile resins or acrylonitrile resins can be used as the two binders.

It is preferable that N-methyl-2-pyrrolidone (which may be hereinafter abbreviated as NMP) be used as the solvent for mixing the inorganic particle with the binder for the porous layer.

Among various organic solvents, NMP has a relatively high boiling point. This property of NMP is convenient for ensuring safety when the solvent is used in large quantity for mass production.

It is preferable that titania with the rutile structure and/or alumina be used as the inorganic particle.

The reason for this limitation is because these substances are highly stable (i.e. not reactive with lithium) inside the battery, can act as an insulator, and are available at low costs. The reason for the structural limitation on titania to the rutile structure is that titania with the anatase structure is capable of intercalation and de-intercalation of lithium ions and can absorb lithium and exhibit electron conductivity, depending on the ambient atmosphere or potential, in which case the battery may possibly lose its capacity or cause short-circuiting.

It should be noted that the inorganic particle is not limited to titania with the rutile structure and alumina; other examples include magnesia and zirconia.

It is preferable that the porous layer have a thickness of 3 μm or less.

This is because too thick a porous layer deteriorates the load characteristic of the battery due to an increase in the internal resistance of the battery or decreases the energy density of the battery due to a decrease in the mass of both positive and negative electrode active materials, although the effects of providing the porous layer will be more remarkable as the layer becomes thicker.

Effects of providing the porous layer are as follows:
Short-circuits between the positive and negative electrodes are prevented in the case of internal short-circuits, whereby the safety level is improved.
The battery performance, such as the cycle characteristics, is improved by enhancing the permeability of the electrolyte solution across the entire surface of the negative electrode and thereby equalizing the reaction.
If cobalt ions or manganese ions are eluted from the positive electrode active material as a result of deep-charging at high temperatures, the porous layer will trap these ions and thereby enhance the cycle characteristic at high temperatures.

It is preferable that the proportion of the binder for the porous layer to the inorganic particle be 1.0 mass % or greater and 30.0 mass % or less.

If the proportion of the binder for the porous layer is less than 1.0 mass %, the dispersion stability of the slurry containing the inorganic particles will be poor. On the other hand, if the proportion of the binder for the porous layer exceeds 30.0 mass %, the binder will fill the spaces between the inorganic particles and extremely decrease the permeability of the electrolyte solution within the porous layer. This situation prevents lithium ions from moving between the positive and negative electrodes, thus significantly deteriorating the battery performance.

The negative electrode manufactured according to the present invention can be used in a non-aqueous electrolyte battery including a positive electrode having a positive electrode active material layer formed on the surface of a positive electrode current collector, a separator disposed between the positive and negative electrodes, and a non-aqueous electrolyte.

The present invention achieves the advantageous effect of ensuring the electron conductivity between the negative electrode active material and the negative electrode current collector by preventing the adhesion strength of the negative electrode current collector and the negative electrode active material from decreasing even if a porous layer is formed on the surface of the negative electrode.

### BRIEF DESCRIPTION OF THE DRAWING

The FIGURE is a cross-sectional view illustrating the structure of a negative electrode.

### PREFERRED EMBODIMENT OF THE INVENTION

Hereinbelow, the present invention is described in further detail. It should be construed, however, that the present invention is not limited to the following embodiment and examples, but various changes and modifications are possible without departing from the scope of the invention.

### Embodiment

### Manufacture of Negative Electrode

(1) Formation of Negative Electrode Active Material Layer

Initially, an aqueous solution of CMC with a concentration of 1.0 mass % was prepared by dissolving CMC (BSH-12, manufactured by Dai-ichi Kogyo Seiyaku Co., Ltd.; degree of etherification, 0.65 to 0.75) in deionized water by using HOMO MIXER™, a mixer of the Primix Corporation. Next, 1000 g of this CMC aqueous solution and 980 g of artificial graphite (average grain size, 21 μm; surface area, 4.0 m²/g) were mixed at 50 rpm for 60 minutes by a HIVIS MIX™ mixer of the Primix Corporation. Then, 500 g of deionized water was added for the purpose of controlling viscosity, and the solution was further mixed at 50 rpm for ten minutes by the same apparatus.

Subsequently, 20 g of styrene-butadiene rubber (SBR) with solid contents of 50 mass % was added to the aqueous solution, which was then mixed at 30 rpm for 45 minutes by HIVIS MIX™ to prepare a negative-electrode slurry. (The resultant slurry contained artificial graphite, CMC and SBR at a mass ratio of 98.0:1.0:1.0.) This negative-electrode slurry was then applied to both sides of a copper negative electrode current collector by a reverse-coating method, followed by drying and rolling processes to form negative electrode active material layers on both sides of the negative electrode current collector. The amount of the negative electrode active material applied was 204 mg/10 cm². The filling density of the negative electrode was 1.60 g/cc.

(2) Formation of Porous Layer

A slurry (250 g) with titanium oxide dispersed therein was prepared by mixing titanium oxide (TiO₂; KR380, manufactured by Titan Kogyo, Ltd.; rutile type; grain size, 0.38 μm) and polyvinylidene fluoride (PVDF) into NMP as a solvent (the proportion of solid contents to the total amount of the slurry was 20 mass %, and the proportion of PVDF to titanium oxide was 2.5 mass %) and then performing a mixing and dispersing process (i.e. the process at a speed of 40 m/s for 30 seconds was repeated three times) using a FILMICS™ mixer of the Primix Corporation. This slurry was applied to the entire surface of one negative electrode active material layer by a gravure coater. Then, the solvent was removed by a drying process to obtain a porous layer on one side of the negative electrode active material layer. Subsequently, another porous layer was similarly formed on the entire surface of the other negative electrode active material layer. Thus, a negative electrode was created. Each porous layer was 3 μm in thickness.

### Manufacture of Positive Electrode

Lithium cobalt oxide as a positive electrode active material, acetylene black as a carbon conductive agent, and PVDF as a binder were mixed together at a mass ratio of 95:2.5:2.5 and then agitated with NMP as a solvent, using a COMBI MIX™ mixer of the Primix Corporation to prepare a positive-electrode slurry. This slurry was applied to both sides of an aluminum foil serving as a positive electrode current collector, and then subjected to drying and rolling processes to create positive electrode active material layers on both sides of the positive electrode current collector. The filling density of the positive electrode active material layers was 3.60 g/cc.

### Preparation of Non-Aqueous Electrolyte Solution

A mixed solvent containing ethylene carbonate (EC) and diethyl carbonate (DEC) at a volume ratio of 3:7 was prepared. Then, LiPF₆ as the main component was dissolved in that solvent at a concentration of 1.0 mol/l to obtain a non-aqueous electrolyte solution.

### Assembly of Battery

A lead terminal was attached to each of the positive and negative electrodes. The two electrodes, with a polyethylene separator interposed in between, were then spirally wound and laterally pressed to obtain a flat electrode assembly. This assembly was put into the internal space of a battery container made of laminated aluminum films, after which the non-aqueous electrolyte solution was injected into the internal space. Finally, the laminated aluminum films were fused together to complete the battery. The design capacity of this battery was 650 mAh. This design capacity was determined based on a charge cut-off voltage of 4.2V.

### Measurement of Degree of Etherification of CMC

The degree of etherification of CMC used for forming the negative electrode active material layer was measured as follows:

Initially, 0.6 g of CMC sample (anhydride) was wrapped with a filter paper and incinerated in a porcelain crucible. After cooling, the sample was put into a 500 ml beaker, into which water (250 ml) and N/10 sulfuric acid (35 ml) were added and boiled for 30 minutes. Subsequently, the sample solution was cooled, and a phenolphthalein indicator was added for back titration of excessive acid with N/10 potassium hydroxide. Based on the titration result, the degree of etherification was calculated using the following equations (1) and (2):

$$A = \frac{af - bf}{Anhydride sample ( g )} - Alkalinity ( or + Acidity ) \qquad ( 1 )$$

A: Amount of N/10 sulfuric acid consumed by combined alkali per 1 g of sample (ml)

a: Amount of N/10 sulfuric acid used (ml)

f: Titer coefficient of N/10 sulfuric acid

b: Titer of N/10 potassium hydroxide (ml)

f′: Titer coefficient of N/10 potassium hydroxide

$$Degree of etherification = \frac{162 \times A}{10000 - 80 A} \qquad ( 2 )$$

162: Molecular weight of glucose

80: Molecular weight of CH₂COONa—H

The alkalinity or acidity was measured as follows:

Approximately 1 g of sample (anhydride) was accurately measured off with a 300 ml Erlenmeyer flask, and approximately 200 ml of water was added to dissolve the sample. Then, N/10 sulfuric acid (5 ml) was added with a pipette, and the sample solution was boiled for 10 minutes. After cooling, a phenolphthalein indicator was added and titration was performed with N/10 potassium hydroxide (S ml). A blank experiment was simultaneously carried out (B ml). Based on the results, The alkalinity was calculated by the following equation (3):

$$Alkalinity = \frac{( B - S ) f}{Anhydride sample ( g )} \qquad ( 3 )$$

f: Titer coefficient of N/10 potassium hydroxide

### EXAMPLES

### Example 1

In Example 1, the negative electrode and battery described in the previous embodiment were used.

The negative electrode and battery thus manufactured are hereinafter referred to as Negative Electrode a1 of the invention and Battery A1 of the invention, respectively.

### Example 2

A negative electrode was manufactured in the same manner as in Example 1 except that the mass ratio of artificial graphite, CMC and SBR used for forming the negative electrode active material layer was 98.3:0.7:1.0.

This negative electrode is hereinafter referred to as Negative Electrode a2 of the invention.

### Example 3

A negative electrode was manufactured in the same manner as in Example 1 except that the mass ratio of artificial graphite, CMC and SBR used for forming the negative electrode active material layer was 97.5:1.5:1.0.

This negative electrode is hereinafter referred to as Negative Electrode a3 of the invention.

### Example 4

A negative electrode was manufactured in the same manner as in Example 1 except that, in the process of forming the negative electrode active material layer, the mixing process after the addition of SBR was performed using a HOMO DISPER™ disperser of the Primix Corporation (at 3000 rpm for 10 minutes) instead of the HIVIS MIX mixer of the Primix Corporation (at 30 rpm for 45 minutes).

This negative electrode is hereinafter referred to as Negative Electrode a4 of the invention.

### Comparative Example 1

A negative electrode and battery were manufactured in the same manner as in Example 1 except that no porous layer was formed on the surface of the negative electrode active material layer.

The negative electrode and battery thus manufactured are hereinafter referred to as Comparative Negative Electrode z1 and Comparative Battery Z 1, respectively.

### Comparative Example 2

A negative electrode and battery were manufactured in the same manner as in Example 1 except that CMC1380 (degree of etherification, 1.00 to 1.50), manufactured by Daicel Chemical Industries, Ltd., was used as CMC.

The negative electrode and battery thus manufactured are hereinafter referred to as Comparative Negative Electrode z2 and Comparative Battery Z2, respectively.

### Comparative Example 3

A negative electrode and battery were manufactured in the same manner as in Comparative Example 2 except that no porous layer was formed on the surface of the negative electrode active material layer.

The negative electrode and battery thus manufactured are hereinafter referred to as Comparative Negative Electrode z3 and Comparative Battery Z3, respectively.

### Experiment 1

The peel strengths of Negative Electrode al of the invention and Comparative Negative Electrodes z1 to z3 were investigated. The result is as shown in Table 1. Specifically, the experiment was carried out as follows:

Using a tension/compression tester (SV-5 and DRS-5R, both manufactured by Imada Seisakusho Co., Ltd.), a circular specimen with an adhesive tape (Scotch™ Double-Coated Tape 666, manufactured by 3M) of 3 cm² was pressed onto the coating surface of each plate-shaped negative electrode and then pulled upward at a constant speed (300 mm/min) to measure the maximum strength during the peeling process. Twenty samples were tested for each electrode. Table 1 shows averages of the measured values.

TABLE 1

| | | | | | Rate of |
|---|---|---|---|---|---|
| | Additive amount | CMC | Presence | | diminution in |
| Negative | of CMC | (degree of | of porous | Peel strength | peel strength |
| electrode | (mass %) | etherification) | layer | (g) | (%) |
| a1 | 1.0 | BSH-12 | Yes | 2995 | 17.3 |
| z1 | | (0.65 to 0.75) | No | 3623 | — |
| z2 | | CMC1380 | Yes | 1062 | 41.0 |
| z3 | | (1.00 to 1.50) | No | 1799 | — |

The rate of diminution in peel strength was computed by comparing two experiments in which the same type of CMC was used. Specifically, Negative Electrode a1 of the invention was compared with Comparative Negative Electrode z1, and Comparative Negative Electrode z2 with Comparative Negative Electrode z3.

As is evident from Table 1, the peel strengths of Negative Electrode a1 of the invention and Comparative Negative Electrode z2, both having a porous layer on the negative electrode active material layer, are lower than those of Comparative Negative Electrodes z1 and z3 if the two types of electrodes which used the same type of CMC are compared with each other (that is, if Negative Electrode a1 is compared with Comparative Negative Electrode z1, or Comparative Negative Electrode z2 with z3). However, by comparing Negative Electrode al with Comparative Negative Electrode z2, both having a porous layer on the negative electrode active material layer, it can also be said that Negative Electrode a1, which used the CMC having a lower degree of etherification, exhibited a lower rate of diminution in peel strength than Comparative Negative Electrode z2, which used the CMC having a higher degree of etherification.

A probable reason for this is as follows. NMP can permeate into the bonding interface between CMC and the negative electrode current collector made of copper and thereby weaken the interaction between them. A hydroxyl group contained in CMC seems to significantly affect the binding strength between CMC and the negative electrode current collector. Therefore, it is presumed that CMC containing a larger amount of hydroxyl groups can more effectively alleviate the buffering effect of NMP. (In other words, it can be said that CMC having a higher degree of etherification is easier to be affected by organic solvents.) Owing to these factors, the use of CMC having a low degree of etherification gives the negative electrode an adequate strength for withstanding a manufacturing process of lithium-ion batteries even if a porous layer containing inorganic particles is formed on the negative electrode.

Although this is a rather empirical rule, it is at least necessary to ensure as high a peel strength as that of Comparative Negative Electrode z3 (approx. 1800 g) so that the negative electrode can successfully undergo the manufacturing process of a negative electrode for lithium-ion batteries, since the electrode is normally handled in a long, rolled shape and often passed through bent sections or slits on the line at considerable speeds. Comparative Negative Electrode z2, for which CMC having a high degree of etherification was used, is unusable since its peel strength (1062 g) is so low that it will lower the yield, deteriorate product qualities or cause other problems that will impede the efficient manufacture of high-performance lithium-ion batteries. On the other hand, Negative Electrode a1 of the invention, for which CMC having a low degree of etherification was used, has such a high peel strength of approximately 3000 g that will not cause a decrease in the yield, deterioration of product qualities and so on. Furthermore, in Negative Electrode a1, the porous layer on the negative electrode active material layer prevents short-circuits between the positive and negative electrodes in the case of internal short-circuits and also helps the electrolyte solution permeate across the entire surface of the electrode. These features enable the efficient manufacture of high-performance lithium-ion batteries.

The location at which the peeling took place during the peel-strength measurement is hereby explained on the basis of the attached FIGURE, which shows the negative electrode current collector 1, negative electrode active material layer 2 and porous layer 3. Observation of the sample electrodes after the peel-strength measurements demonstrated that peeling occurred at the interface between the negative electrode current collector 1 and the negative electrode active material layer 2 in most of the samples, whereas, in Negative Electrode a1 of the invention and Comparative Negative Electrode z1 having high peel strengths, the peeling was located either inside the negative electrode active material layer 2 or at the interface between the negative electrode active material layer 2 and the porous layer 3. (For Comparative Electrode z1, the peeling was found inside the negative electrode active material layer 2 since the electrode had no porous layer 3.)

The reason why the peeling took place at the interface between the negative electrode active material layer 2 and the porous layer 3 as in Negative Electrode a1 of the invention is most likely because appropriate control of the degree of etherification of CMC alleviates the influence on CMC resulting from the permeation of NMP, causing an easy-to-peel region to shift from the interface between the negative electrode current collector 1 and the negative electrode active material layer 2 to that between the negative electrode active material layer 2 and the porous layer 3. The inventors focused on this issue and investigated a cross section of the negative electrode active material layer 2. The result showed that CMC is abundantly distributed on the side of the negative electrode active material layer 2 closer to the negative electrode current collector 1, and SBR (i.e. the additional binder for the negative electrode active material layer) on the side of the negative electrode active material layer 2 closer to the porous layer 3. The reason for this distribution is probably because CMC has a high degree of affinity with the negative electrode active material and can be uniformly distributed across the entirety of the electrode, whereas SBR tends to migrate into the vicinity of the surface during the drying process, similar to water in a drying process.

This result suggests that CMC governs the bonding strength between the negative electrode current collector 1 and the negative electrode active material layer 2, and that changing the type (or degree of etherification) of CMC can effectively enhance the peel strength of a porous layer containing inorganic particles formed on the surface of the negative electrode active material layer 2. Meanwhile, SBR, i.e. the additional binder for the negative electrode active material layer, seems to govern the bonding strength between the porous layer 3 and the negative electrode active material layer 2. However, in this case it is impossible to simply apply the technique used in the previous case of improving the bonding strength between the negative electrode current collector 1 and the negative electrode active material layer 2; the latter case should be addressed from a different viewpoint since it requires consideration of the binder contained in the porous layer 3. Specifically, in the previously described embodiment, SBR was used as the additional binder for the negative electrode active material layer, and PVDF as the binder for the porous layer. These binders have totally different structures, so that the structural interaction between the two materials should be rather weak. Such a weak interaction between the two binders leads to a low bonding strength between the negative electrode active material layer 2 and the porous layer 3. This is the probable reason why the peel strength of Negative Electrode a1 of the invention was lower than that of Comparative Negative Electrode z1.

Thus, in order to manufacture negative electrodes having higher peel strength in the case where the porous layer 3 is present, it is preferable that materials with similar structures be used for both the additional binder for the negative electrode active material layer and the binder for the porous layer. The use of two materials having similar structures should increase their interaction and enhance the binding strength accordingly. Given the current combination of SBR and PVDF, it is difficult to strengthen the interaction. A preferable alternative is acrylic resins, some of which are known to be water-soluble and others water-insoluble. Combinations of these resins should also be the most preferable for the purpose of ensuring dispersibility, binding strength and flexibility. Accordingly, for example, it is desirable to use an acrylic resin as a water-based binder for the negative electrode active material layer and another acrylic resin as a non-water based binder for the porous layer.

### Experiment 2

The peel strengths of Negative Electrodes a1 to a3 of the invention were investigated. The result is as shown in Table 2. The method of this experiment was the same as in Experiment 1.

TABLE 2

| | CMC | | Additive amount | Peel |
|---|---|---|---|---|
| Negative | (degree of | Presence of | of CMC | strength |
| electrode | etherification) | porous layer | (mass %) | (g) |
| a2 | BSH-12 | Yes | 0.7 | 1810 |
| a1 | (0.65 to 0.75) | | 1.0 | 2995 |
| a3 | | | 1.5 | 4534 |

As is evident from Table 2, the peel strength increases with an increase in the additive amount of CMC. Even Negative Electrode a2, whose CMC content is the lowest (0.7 mass %), exhibits a peel strength higher than that of Comparative Negative Electrode z3. The peel strength (1810) is high enough for the electrode to undergo an actual manufacturing process. This result confirms that the additive amount of CMC should preferably be 0.7 mass % or greater. However, though not shown in Table 2, it was found that adding CMC by an amount exceeding 1.5 mass % may result in too high a CMC concentration in the vicinity of the negative electrode active material, which impedes the intercalation and de-intercalation of lithium ions and thereby deteriorates the performance of a resultant battery using the negative electrode. Thus, it is preferable that the additive amount of CMC be 0.7 mass % or greater and 1.5 mass % or less.

Although no detailed study of the degree of etherification has been conducted, it is clear from the discussions of the present specification that the peel strength can be significantly improved by using CMC with a lower degree of etherification rather than a higher degree of etherification.

### Experiment 3

The peel strengths of Negative Electrodes a1 and a4 of the invention, which were manufactured using different dispersing methods after the addition of SBR, were investigated. The result is as shown in Table 3. The method of this experiment was the same as in Experiment 1.

TABLE 3

| | CMC | Presence | Additive amount | Dispersion | |
|---|---|---|---|---|---|
| Negative | (degree of | of porous | of CMC | method after | Peel strength |
| electrode | etherification) | layer | (mass %) | addition of SBR | (g) |
| a1 | BSH-12 | Yes | 1.0 | Low shear | 2995 |
| a4 | (0.65 to 0.75) | | | High shear | 2022 |

As is evident from Table 3, Negative Electrode a1, for which a low-shear dispersion method was used in the kneading process after the addition of SBR, has a higher peel strength than that of Negative Electrode a4, for which a high-shear dispersion method was used. This is probably because the high-shear dispersion method causes aggregation of molecules of a latex binder (e.g. SBR), which is used as the additional binder for the negative electrode active material layer and mainly intended to give flexibility to the layer, and this aggregation impedes the formation of a negative-electrode slurry having an intended uniformity.

It seems that there is no significant difference between the two shear dispersion methods as far as the CMC-dispersion effect is concerned. However, to improve the overall uniformity and other qualities of a resultant electrode plate, the low-shear dispersion method should be preferably used whenever possible as the kneading method in the process of preparing the negative-electrode slurry.

The low-shear dispersion method is a method by which particles are dispersed by a moderate force that will not pulverize them. For example, if the HIVIS MIX™ mixer of the Primix Corporation is used, the device should be operated at 50 rpm or lower.

### Experiment 4

Battery A1 of the invention and Comparative Battery Z1 were stored at a high temperature and later investigated in terms of the voltage change before and after the storage, the internal-resistance change before and after the storage, the ratio of remaining capacity after the storage, and the ratio of recovery capacity after the storage. The results are as shown in Table 4. The experiment conditions were as follows.

### Charge and Discharge Conditions

Charging Conditions

The batteries were charged under the conditions that the current is held at 1.0 It (650 mA) until the battery voltage reaches 4.20 V and then the voltage is held at 4.20V until the current declines to 1/20 It (32.5 mA).

Discharging Condition

The batteries were discharged under the condition that the current is held at 1.0 It (650 mA) until the battery voltage declines to 2.75 V.

The interval between the charging and discharging operations was 10 minutes.

### Charge-Preservation Property

Storage Conditions

The batteries were subjected to one cycle of charge-discharge operations under the above-described conditions, and then recharged to 4.20 V under the aforementioned charging conditions and left at 60° C. for 20 days.

Calculation of Ratio of Remaining Capacity

After the storage test under the above conditions was completed, the batteries were cooled to room temperature and their remaining capacity was measured by discharging them under the same condition as specified previously. Then, using the equation (4) below, the ratio of remaining capacity was calculated from the discharged capacity (remaining capacity) at the first discharging operation after the storage test and the discharged capacity before the test.

Rate of remaining capacity (%)=(DC₁/DC₀)×100 (4)

DC₀: Discharged capacity before the storage test

DC₁: Discharged capacity at the first discharging operation after the storage test

Calculation of Ratio of Recovery Capacity

After the remaining capacity was measured, the recovery capacity of the batteries was measured by charging them under the same charging conditions as specified previously and then discharging them under the same discharging condition as specified previously. Then, using the equation (5) below, the ratio of recovery capacity was calculated from the discharged capacity (remaining capacity) at the second discharging operation after the storage test and the discharged capacity before the test.

Rate of recovery capacity (%)=(DC₂/DC₀)×100 (5)

DC₀: Discharged capacity before the storage test

DC₂: Discharged capacity at the second discharging operation after the storage test

TABLE 4

| | | | | | Ratio of | Ratio of |
|---|---|---|---|---|---|---|
| | CMC | | | | remaining | recovery |
| | (degree of | Presence of | Voltage change | Internal-resistance | capacity | capacity |
| Battery | etherification) | porous layer | (V) | change (mΩ) | (%) | (%) |
| A1 | BSH-12 | Yes | 4.19 → 4.09 | 65.1 → 80.0 | 79.7 | 89.7 |
| | (0.65 to 0.75) | | (−0.10) | (+14.9) | | |
| Z1 | | No | 4.19 → 4.09 | 66.0 → 78.5 | 79.2 | 89.4 |
| | | | (−0.10) | (+12.5) | | |

As is evident from Table 4, Battery A1 was comparable to Comparative Battery Z1 in terms of the voltage change before and after the storage, the internal-resistance change before and after the storage, the ratio of remaining capacity after the storage, and the ratio of recovery capacity after the storage. Its electrochemical characteristics agreed with the expectations except for the peel strength of the electrode plate. It should be noted that Battery A1 will probably exceed Comparative Battery Z1 in terms of the ratios of remaining capacity and recovery capacity after the storage if the batteries are stored under severer conditions, such as holding the charging voltage at 4.40 V or higher.

### Experiment 5

Battery A1 of the invention and Comparative Batteries Z1 to Z3 were subjected to a charge/discharge cycle test in which the charge-discharge operations were repeated 500 cycles under the charge and discharge conditions specified in Experiment 4 (and at a temperature of 25° C.), and their capacity retention ratios were calculated by equation (6) below. The result is as shown in Table 5.

Capacity retention ratio (%)=(DC₅₀₀/DC₀₀₁)×100 (6)

DC₅₀₀: Discharged capacity at the 500^{th} cycle

DC₀₀₁: Discharged capacity at the first cycle

TABLE 5

| | | | Capacity retention |
|---|---|---|---|
| | | | ratio after |
| | CMC | Presence of | 500 cycles |
| Battery | (degree of etherification) | porous layer | (%) |
| A1 | BSH-12 | Yes | 91.2 |
| Z1 | (0.65 to 0.75) | No | 89.8 |
| Z2 | CMC1380 | Yes | 91.1 |
| Z3 | (1.00 to 1.50) | No | 90.1 |

As is evident from Table 5, Battery A1 and Comparative Battery Z2, both having a porous layer, have better cycle characteristics in comparison to Comparative Batteries Z1 and Z3, which had no porous layer. This is probably because the porous layer produced an improved circulation of the electrolyte solution inside Battery A1 and Comparative Battery Z2. The capacity retention ratio of Battery A1 was approximately equal to that of Comparative Battery Z2. This result demonstrates that the degree of etherification of CMC scarcely affects the ratio. However, as stated in Experiment 4, Battery A1 will probably exceed Comparative Battery Z2 in terms of the capacity retention ratio if the batteries are charged and discharged under severer conditions, such as a higher charging voltage.

The results of Experiments 4 and 5 demonstrate that use of the configuration according to the present invention makes it possible to manufacture a negative electrode having a high-quality porous layer with a good peel strength and also a battery using such a negative electrode without deteriorating the battery performance.

### Other Embodiments

(1) The positive electrode active material is not limited to lithium cobalt oxide. Other usable materials include lithium composite oxides containing cobalt or manganese, such as lithium cobalt-nickel-manganese composite oxide, lithium aluminum-nickel-manganese composite oxide, and lithium aluminum-nickel-cobalt composite oxide. Spinel-type lithium manganese oxides and olivine-type lithium iron phosphates are also available.

(2) The method for preparing a positive electrode mixture is not limited to wet mixing methods. For example, it may include dry mixing a positive electrode active material and a conductive agent beforehand, then mixing them with PVDF and NMP, and stirring.

(3) The negative electrode active material is not limited to artificial graphite; any kind of material is usable as far as it is capable of intercalation and de-intercalation of lithium ions. Examples include graphite, coke, tin oxide, metallic lithium, silicon, and mixtures of these materials.

(4) The lithium salt in the electrolyte solution is not limited to LiPF₆. Other usable compounds include LiBF₄, LiN(SO₂CF₃)₂, LiN(S0₂C₂F₅)₂ and LiPF₆₋ₓ(CₙF₂ₙ₊₁)ₓ [where 1<x<6, and n=1 or 2]. It is also possible to use a mixture of two or more of these compounds. There is no specific limitations on the concentration of the lithium salt, but the concentration should be preferably from 1.0 to 1.5 mol per one liter of electrolyte solution. The solvent of the electrolyte solution is not limited to ethylene carbonate (EC) and diethyl carbonate (DEC); nevertheless it is preferable to use carbonate solvents, such as propylene carbonate (PC), γ-butyrolactone (GBL), ethylmethyl carbonate (EMC) and dimethyl carbonate (DMC). Combining a cyclic carbonate and a chain carbonate is further preferable.

(5) The present invention is not limited to liquid-based batteries but also applicable to gel-based polymer batteries. Examples of the polymer materials available in the latter case include polyether solid polymers, polycarbonate solid polymers, polyacrylonitrile solid polymers, oxetane polymers, epoxy solid polymers, copolymers of two or more of these polymers, cross-linked polymers and PVDF. Any of these polymers can be combined with a lithium salt and an electrolyte and turned into a gel which can be used as a solid electrolyte.

The present invention can be suitably applied to the power sources of mobile phones, notebook computers, PDAs and other mobile information devices, and particularly to those applications in which high capacity is required. The application area is expected to expand to high-power applications that require the battery to continuously operate at high temperatures, including hybrid electric vehicles and electric tools whose batteries are subjected to severe operation environments.

What is claimed is:

1. A negative electrode for a non-aqueous electrolyte battery, including a negative electrode active material layer formed on a negative electrode current collector, the negative electrode active material layer containing a negative electrode active material and a water-based binder for the negative electrode active material layer, wherein:
a porous layer containing an inorganic particle and a non-water based binder for the porous layer is formed on a surface of the negative electrode active material layer; and
the binder for the negative electrode active material layer contains carboxymethyl cellulose whose degree of etherification is 0.5 or greater and 0.75 or less.

2. The negative electrode according to claim 1, wherein the degree of etherification of the carboxymethyl cellulose is 0.65 or greater and 0.75 or less.

3. The negative electrode according to claim 1, wherein a proportion of carboxymethyl cellulose to a total amount of the negative electrode active material layer is 0.7 mass % or greater and 1.5 mass % or less.

4. The negative electrode according to claim 2, wherein a proportion of carboxymethyl cellulose to a total amount of the negative electrode active material layer is 0.7 mass % or greater and 1.5 mass % or less.

5. The negative electrode according to claim 1, wherein a binder for giving flexibility to the negative electrode active material layer is contained as an additional binder for the negative electrode active material layer.

6. The negative electrode according to claim 2, wherein a binder for giving flexibility to the negative electrode active material layer is contained as an additional binder for the negative electrode active material layer.

7. The negative electrode according to claim 5, wherein a proportion of the additional binder for the negative electrode active material layer to a total amount of the negative electrode active material layer is 0.5 mass % or greater and 1.5 mass % or less.

8. The negative electrode according to claim 6, wherein a proportion of the additional binder for the negative electrode active material layer to a total amount of the negative electrode active material layer is 0.5 mass % or greater and 1.5 mass % or less.

9. The negative electrode according to claim 5, wherein a structure of the additional binder for the negative electrode active material layer is similar to that of the binder for the porous layer.

10. The negative electrode according to claim 6, wherein a structure of the additional binder for the negative electrode active material layer is similar to that of the binder for the porous layer.

11. The negative electrode according to claim 1, wherein N-methyl-2-pyrrolidone be used as a solvent for mixing the inorganic particle with the binder for the porous layer.

12. The negative electrode according to claim 2, wherein N-methyl-2-pyrrolidone be used as a solvent for mixing the inorganic particle with the binder for the porous layer.

13. The negative electrode according to claim 1, wherein titania with the rutile structure and/or alumina is used as the inorganic particle.

14. The negative electrode according to claim 2, wherein titania with the rutile structure and/or alumina is used as the inorganic particle.

15. The negative electrode according to claim 1, wherein the porous layer have a thickness of 3 μm or less.

16. The negative electrode according to claim 2, wherein the porous layer have a thickness of 3 μm or less.

17. The negative electrode according to claim 1, wherein a proportion of the binder for the porous layer to the inorganic particle is 1.0 mass % or greater and 30.0 mass % or less.

18. The negative electrode according to claim 2, wherein a proportion of the binder for the porous layer to the inorganic particle is 1.0 mass % or greater and 30.0 mass % or less.

19. A non-aqueous electrolyte battery comprising:
a negative electrode according to claim 1;
a positive electrode having a positive electrode active material layer formed on a surface of a positive electrode current collector;
a separator disposed between the positive and negative electrodes; and
a non-aqueous electrolyte.

20. A non-aqueous electrolyte battery comprising:
a negative electrode according to claim 2;
a positive electrode having a positive electrode active material layer formed on a surface of a positive electrode current collector;
a separator disposed between the positive and negative electrodes; and
a non-aqueous electrolyte.
